(19) United States
(12) Patent Application Publication
(10) Pub. No.: US 2021/0118253 A1
(43) Pub. Date: Apr. 22, 2021

(54) MONITORING CONTROL APPARATUS, MONITORING SYSTEM, MONITORING CONTROL METHOD, AND PROGRAM

(71) Applicant: NEC CORPORATION, Tokyo (JP)

(72) Inventor: Christian SOETJIPTO, Tokyo (JP)

(73) Assignee: NEC CORPORATION, Minato-ku (JP)

(21) Appl. No.: 16/634,396

(22) PCT Filed: Jul. 27, 2018
(86) PCT No.: PCT/JP2018/028256

§ 371 Date: Jan. 27, 2020

(30) Foreign Application Priority Data
Jul. 28, 2017 (JP) 2017-146665

(51) Int. Cl. G07C 9/00; G08B 21/04; G08B 21/22

(52) U.S. Cl. CPC G07C 9/00309; G08B 21/0476; G07C 9/00896; G08B 21/0469; G08B 21/22

(57) ABSTRACT

A monitoring control apparatus includes: a watcher determination part that determines, by using communication statuses of devices included in premise networks of a plurality of customers, a watcher(s) corresponding to a monitoring target(s) from the plurality of customers; and a notification part that notifies, when an abnormal situation(s) has happened to the monitoring target(s), the watcher(s) of the occurrence of the abnormal situation(s).

### CROSS REFERENCE TO RELATED APPLICATIONS

This application is a National Stage of International Application No. PCT/JP2018/028256, filed Jul. 27, 2018, claiming priority to Japanese Patent Application No. 2017-146665, filed Jul. 28, 2017, the contents of all of which are incorporated herein by reference in their entirety.

### FIELD

The present invention relates to a monitoring control apparatus, a monitoring system, a monitoring control method, and a program.

### BACKGROUND

Along with the aging society, recent years have seen an increase in the number of households of elderly people (for example, 65 years old or older) living alone and in the number of households of married elderly couples. Families, relatives, etc. who live away from elderly people living alone, married elderly couples, etc. (these people will simply be referred to as elderly people) regularly contact their elderly people and check their safety. However, if an emergency situation has happened to an elderly person and the elderly person cannot report the emergency situation, his/her family member or the like cannot grasp that the emergency situation has happened to the elderly person. Thus, it is desirable that the safety of the elderly person be properly checked and that a prompt response need to be made without contacting the elderly person.

PTL 1 discloses a technique in which a radio wave is received from a lighting device in response to turning on or turning off of the lighting device. The lighting device transmits the radio wave when turned on or turned off. In this technique, a terminal of a watcher is notified of information about turning on or turning off of the lighting device as information about the safety of the target(s) who is watched.

PTL 2 discloses a system in which a behavior monitoring sensor that monitors behavior of a monitoring target(s) is installed inside a residence(s) of the monitoring target(s). Behavior history data based on an output from the behavior monitoring sensor is reported to a service provider. In the system disclosed in PTL 2, whether the behavior of the monitoring target(s) is normal or not is determined based on the behavior history data. In addition, in the system disclosed in PTL 2, if it is determined that the behavior of the monitoring target(s) is not normal, a registered emergency operator that has made a contract with the service provider is requested to visit and check the monitoring target(s).
PTL 1: Japanese Patent Kokai Publication No. JP2016-218969A
PTL 2: Japanese Patent Kokai Publication No. JP2002-324291A

### SUMMARY

The disclosure of the above PTLs is incorporated herein by reference thereto. The following analysis has been made from the viewpoint of the present invention.

If a family member(s) or the like who lives away from his/her elderly person(s) cannot contact the elderly person(s), there are cases in which the family member(s) contacts a person who lives near the elderly person(s), a caregiver, or the like and requests to check the safety of the elderly person(s). However, when the family member(s) or the like of the elderly person(s) requests a person or the like who lives near the elderly person(s) to check the safety of the elderly person(s), the person or the like who lives near the elderly person(s) may not always be contacted successfully.

In addition, when the person or the like who lives near the elderly person(s) is not home, the family member(s) or the like of the elderly person(s) cannot request to check the safety of the elderly person(s). When the family member(s) or the like of the elderly person cannot request the person who lives near the elderly person(s) to check the safety of the elderly person(s), the family member(s) or the like needs to contact another person who lives near the elderly person(s) and request this person to check the safety of the elderly person(s). In this case, it takes time for the family member(s) of the like of the elderly person(s) to check the safety of the elderly person(s).

According to the technique disclosed in PTL 1, when a family member(s) or the like lives away from his/her elderly person(s), a caregiver or the like serves as a watcher and checks the safety of the elderly person(s). In addition, according to the technique disclosed in PTL 2, a service provider makes a contract with an operator (a taxi company, a nursing-care company, or the like) and requests the operator to perform an emergency operation. Thus, according to the techniques disclosed in PTLs 1 and 2, the family member(s) or the like of the elderly person(s) needs to make a predetermined contract and take financial burden, to check the safety of the elderly person(s).

In addition, the number of elderly people is predicted to increase in the future, and an individual caregiver or the like is predicted to take care of more elderly people. Thus, if an individual caregiver or the like checks the safety of elderly people by using the techniques disclosed in PTLs 1 and 2, more burden could be placed on the individual caregiver or the like as the number of elderly people increases.

Thus, it is an object of the present invention to provide a monitoring control apparatus, a monitoring system, a monitoring control method, and a program that contribute to checking the safety of a monitoring target(s) through mutual cooperation of customers of a monitoring service.

According to a first aspect, there is provided a monitoring control apparatus. The monitoring control apparatus includes a watcher determination part that determines, by using communication statuses of devices included in premise networks of a plurality of customers, a watcher(s) corresponding to a monitoring target(s) from the plurality of customers.

The monitoring control apparatus also includes a notification part that notifies, when an abnormal situation(s) has happened to the monitoring target(s), the watcher(s) of the occurrence of the abnormal situation(s).

According to a second aspect, there is provided a monitoring system. The monitoring system includes: a communication control apparatus that acquires communication statuses of devices included in a premise network(s) of a plurality of customers; and a monitoring control apparatus that acquires the communication statuses from the communication control apparatus.

The monitoring control apparatus includes a watcher determination part that determines, by using the communication statuses of the devices included in the premise network(s) of the plurality of customers, a watcher(s) corresponding to a monitoring target(s) from the plurality of customers.

The monitoring control apparatus also includes a notification part that notifies, when an abnormal situation(s) has happened to the monitoring target(s), the watcher(s) of the occurrence of the abnormal situation(s).

According to a third aspect, there is provided a monitoring control method. The monitoring control method includes determining, by using communication statuses about devices included in premise networks of a plurality of customers, a watcher(s) corresponding to a monitoring target(s) from the plurality of customers.

The monitoring control method also includes notifying, when an abnormal situation(s) has happened to the monitoring target(s), the watcher(s) of the occurrence of the abnormal situation(s).

This method is associated with a certain machine referred to as a monitoring control apparatus that acquires communication statuses of devices included in premise networks of a plurality of customers.

According to a fourth aspect, there is provided a program. The program causes a computer to perform processing for determining, by using communication statuses about devices included in premise networks of a plurality of customers, a watcher(s) corresponding to a monitoring target(s) from the plurality of customers.

The program also causes a computer to perform processing for notifying, when an abnormal situation(s) has happened to the monitoring target(s), the watcher(s) of the occurrence of the abnormal situation(s).

This program can be stored in a computer-readable storage medium. The storage medium may be a non-transient storage medium such as a semiconductor memory, a hard disk, a magnetic storage medium, or an optical storage medium. The present invention can be embodied as a computer program product.

According to the individual aspects, there are provided a monitoring control apparatus, a monitoring system, a monitoring control method, and a program that contribute to checking the safety of a monitoring target(s) through mutual cooperation of customers of a monitoring service.

### BRIEF DESCRIPTION OF DRAWINGS

FIG. 1 illustrates an outline according to an exemplary embodiment.

FIG. 2 is a block diagram illustrating an example of an overall configuration of a monitoring system 1 according to a first exemplary embodiment.

FIG. 3 is a block diagram illustrating an example of an internal configuration of a monitoring control apparatus 112.

FIG. 4 is a sequence diagram illustrating an example of an operation of the monitoring system 1 according to the first exemplary embodiment.

FIG. 5 is a sequence diagram illustrating an example of an operation of the monitoring system 1 according to the first exemplary embodiment.

FIG. 6 is a sequence diagram illustrating an example of an operation of the monitoring system 1 according to the first exemplary embodiment.

FIG. 7 is a block diagram illustrating an example of an overall configuration of a monitoring system 1a according to a second exemplary embodiment.

FIG. 8 is a sequence diagram illustrating an example of an operation of the monitoring system 1a according to the second exemplary embodiment.

FIG. 9 is a block diagram illustrating an example of an internal configuration of a monitoring control apparatus 112a according to a variation of the second exemplary embodiment.

FIG. 10 is a block diagram illustrating an example of an overall configuration of a monitoring system 1b according to a third exemplary embodiment.

FIG. 11 is a sequence diagram illustrating an example of an operation of the monitoring system 1b according to the third exemplary embodiment.

FIG. 12 is a block diagram illustrating an example of an internal configuration of a monitoring control apparatus 112b according to a variation of the third exemplary embodiment.

### PREFERRED MODES

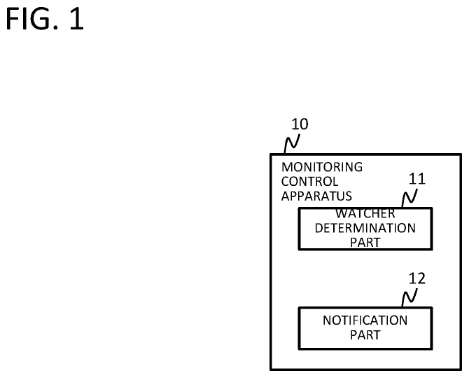

First, an outline of an exemplary embodiment will be described with reference to FIG. 1. The reference characters that denote various elements in the following outline are merely used as examples for convenience to facilitate understanding of the present invention. Therefore, the description of the outline is not intended to impose any limitations. In addition, an individual connection line between blocks in an individual block diagram signifies both one-way and two-way directions. While not explicitly illustrated in the block diagrams, the internal configuration diagrams, the connection diagrams, etc. in the disclosure of the present application, an input port and an output port exist at an input end and an output end of an individual connection line. The same holds true with regard to input-output interfaces.

As described above, there is demanded a monitoring control apparatus that contributes to checking the safety of a monitoring target(s) through mutual cooperation of customers of a monitoring service.

As an example, a monitoring control apparatus 10 illustrated in FIG. 1 is provided. The monitoring control apparatus 10 includes a watcher determination part 11 and a notification part 12.

The watcher determination part 11 uses communication statuses of devices included in premise networks of a plurality of (two or more) customers and determines a watcher(s) corresponding to a monitoring target(s) from the plurality of customers. The individual customers have a contract as those who are provided with a monitoring service that uses the monitoring control apparatus 10. In addition, the watcher(s) checks the safety of the monitoring target(s).

If an abnormal situation has happened to the monitoring target, the notification part 12 notifies the watcher(s) corresponding to the monitoring target(s) of the occurrence of the abnormal situation.

For example, based on the communication statuses of devices in the residences of the customers, the monitoring control apparatus 10 may select a watcher(s) from the customers who live near an elderly person living alone. If an abnormal situation has happened to the elderly person living alone (the monitoring target), the monitoring control apparatus 10 notifies the watcher(s) that the abnormal situation has happened to the elderly person living alone.

Thus, the monitoring control apparatus 10 contributes to checking the safety of the monitoring target(s) through mutual cooperation of customers of the monitoring service.

### First Exemplary Embodiment

A first exemplary embodiment will be described in more detail with reference to drawings.

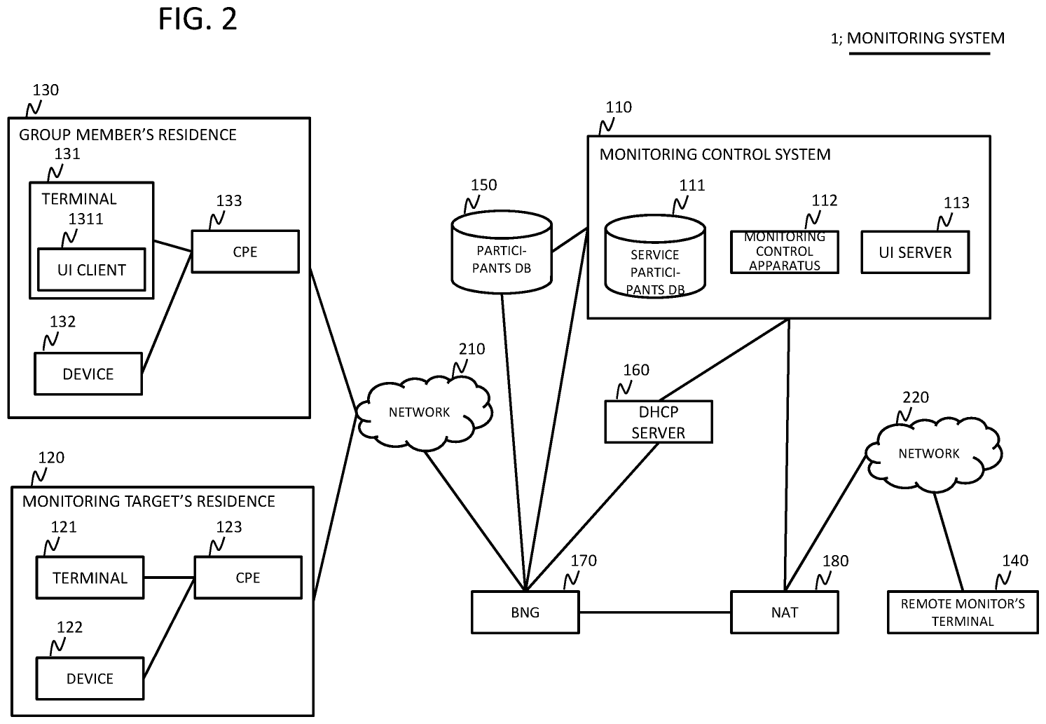

FIG. 2 is a block diagram illustrating an example of an overall configuration of a monitoring system 1 according to the present exemplary embodiment.

In the following description, “monitoring service” refers to a service provided by using the monitoring system 1 according to the present exemplary embodiment. In addition, in the following description, a watcher(s) associated with a monitoring target(s) will be referred to “a remote monitor(s)”. For example, a remote monitor(s) may be a family member(s) or the like of the monitoring target(s). In addition, the following description assumes that the watcher(s) is different from the monitoring target(s) and the remote monitor(s).

In addition, in the following description, a candidate for a watcher will be referred to as “a watcher candidate”. In addition, in the following description, a group of watcher candidates will be referred to as “a group”. In addition, in the following description, a customer included in a group will be referred to as “a group member”.

In addition, in the following description, the customers of the monitoring service will simply be referred to as “customers”. The customers include the monitoring target(s), the remote monitor(s), and the group member(s).

A terminal 121, a device 122, and a CPE (Customer Premise Equipment) 123 are included in a monitoring target's residence 120. While FIG. 2 illustrates only one device 122 and only one terminal 121, neither the number of devices 122 nor the number of terminals 121 is limited to one. In the monitoring target's residence 120, two or more devices 122 and two or more terminals 121 may be included.

In addition, a terminal 131, a device 132, and a CPE 133 are included in a group member's residence 130. While FIG. 2 illustrates only one device 132 and only one terminal 131, neither the number of devices 132 nor the number of terminals 131 is limited to one. In the group member's residence 130, two or more devices 132 and two or more terminals 131 may be included.

While FIG. 2 illustrates only one monitoring target's residence 120, the number of monitoring targets' residences 120 is not limited to one. In addition, while FIG. 2 illustrates only one group member's residence 130, the number of group members' residences 130 is not limited to one. The monitoring system 1 may of course include two or more monitoring targets' residences 120 and two or more group members' residences 130.

The terminal 121 is an information processing device (a computer) used by the monitoring target. The terminal 121 may be a PC (Personal Computer), a smartphone, or the like. The following description assumes that, when the terminal 121 is present in the monitoring target's residence 120, the terminal 121 is included in an premise network of the monitoring target's residence 120. When the terminal 121 is included in the premise network of the monitoring target's residence 120, the terminal 121 connects to a network 210 outside the monitoring target's residence 120 via the CPE 123 in the monitoring target's residence 120.

The terminal 131 is an information processing device (a computer) used by the group member. The terminal 131 may be a PC, a smartphone, or the like. The following description assumes that, when the terminal 131 is included in a premise network of the group member's residence 130, the terminal 131 is included in the premise network of the group member's residence 130. When the terminal 131 is included in the premise network of the group member's residence 130, the terminal 131 connects to the network 210 outside the group member's residence 130 via the CPE 133 in the group member's residence 130.

In addition, the terminal 131 includes a UI (User Interface) client 1311. The UI client 1311 is an application program installed to the terminal 131. The terminal 131 uses the UI client 1311 to receive information inputted by its user. In addition, the terminal 131 presents information transmitted from a monitoring control system 110 to its user by using the UI client 1311.

The device 122 includes a device that executes a communication function. The device 122 may be a PC, a smartphone, or the like. The device 122 may be a home electrical appliance (a refrigerator, a microwave, or the like) having a communication function.

The device 122 connects to the network 210 (for example, the Internet) outside the monitoring target's residence 120 via the CPE 123 in the monitoring target's residence 120. If the device 122 connects to the network 210 outside the monitoring target's residence 120, a connection session is established between the device 122 and a connection destination network.

Likewise, the device 132 includes a device that executes a communication function. The device 132 may be a PC, a smartphone, or the like. The device 132 may be a home electrical appliance (a refrigerator, a microwave, or the like) having a communication function.

The device 132 connects to the network 210 (for example, the Internet) outside the group member's residence 130 via the CPE 133 in the group member's residence 130. If the device 132 connects to the network 210 outside the group member's residence 130, a connection session is established between the device 132 and a connection destination network.

A remote monitor's terminal 140 is an information processing device (a computer) used by a remote monitor. The remote monitor's terminal 140 may be a PC, a smartphone, or the like. The remote monitor's terminal 140 connects to a UI server 113 via a network 220 (for example, the Internet).

In addition, in the following description, both a device (the device 122 or the device 132) included in the premise network of a person X and a terminal (the terminal 121 or the terminal 131) included in the premise network of the person X will be referred to as “a premise device of the person X”, for convenience of the description. In addition, in the following description, a premise device of a customer (participant) refers to at least one of the terminals 121, the device 122, the device 132, and the terminal 131.

In addition, in the following description, when the terminal 121, the terminal 131, and the remote monitor's terminal 140 do not need to be distinguished from one another, these terminals will simply be referred to as “a terminal” or “a terminal used by a customer”.

The CPE 123 is a gateway device that accommodates a connection session from a premise device (the terminal 121 or the device 122) of the monitoring target and communicates with the network 210 outside the monitoring target.

Likewise, the CPE 133 is a gateway device that accommodates a connection session from a premise device (the terminal 131 or the device 132) of the group member and communicates with the network 210 outside the group member.

A DHCP (Dynamic Host Configuration Protocol) server 160 allocates a private IP (Internet Protocol) address to a premise device of a customer. The premise device of the customer connects to the premise network of the customer or the network 210 outside the customer's residence by using the allocated private IP address.

Specifically, a premise device of a customer transmits a message requesting allocation of a private IP address to the DHCP server 160. The message transmitted by the premise device of the customer includes information indicating, for example, the kind of the device that has transmitted the message. When the DHCP server 160 receives the message requesting the allocation of a private IP address, the DHCP server 160 determines an IP address to be allocated and allocates the IP address to the device that has transmitted the message as the private IP address.

Consequently, by allocating the private IP address to the premise device of the customer, the DHCP server 160 manages the kind of the device and the allocated private IP address in association with each other.

A BNG (Broadband Network Gateway) 170 is an information processing apparatus (a computer) that provides the router functions of the premise networks of the plurality of customers in a concentrated manner.

A customers (participants) DB (Database) 150 is an information processing apparatus (a computer) that stores and manages information about the customers who have a contract as the customers of the monitoring service. In addition, the customers DB 150 performs processing for addition, updating, deletion, etc. of the information about the customers. The information about the customers includes, for example, contract numbers, personal information about the customers, and information about the monitoring service on which the customers have made a contract.

A NAT (Network Address Translation) 180 (a communication control apparatus) acquires the communication statuses of the devices included in the premise networks of the plurality of customers.

Specifically, the NAT 180 converts a private IP address corresponding to a packet transmitted from a premise device of a customer into a global IP address. Next, the NAT 180 forwards the packet transmitted from the premise device of the customer by using the global IP address obtained by the above conversion. In other words, the packet forwarded from the premise device of the customer is forwarded to a destination via the NAT 180.

In addition, the NAT 180 generates connection session information based on a connection session between the premise device of the customer and the NAT 180.

If an abnormal situation has happened to a monitoring target(s), the monitoring control system 110 notifies a remote monitor(s) and a watcher(s). The monitoring control system 110 includes a service customers DB 111, a monitoring control apparatus 112, and the UI server 113.

The monitoring control apparatus 112 acquires the communication statuses of the devices included in the premise networks of the plurality of customers from the NAT 180 based on vCPE (virtualized CPE). Based on vCPE, the NAT 180 collectively manages the communication statuses of the premise devices of the plurality of customers. Thus, by using the NAT 180, the monitoring control apparatus 112 can simultaneously monitor the communication statuses of the premise device of the plurality of customers. The monitoring control apparatus 112 will be described in detail below.

The UI server 113 is an information processing apparatus (a computer) that receives information from the terminals used by the customers. The UI server 113 transmits the information received from the terminals used by the customers to the monitoring control apparatus 112. The UI server 113 receives information addressed to the terminals used by the customers from the monitoring control apparatus 112. The UI server 113 transmits the information received from the monitoring control apparatus 112 to the terminals used by the customers.

The service customers DB 111 is an information processing apparatus (a computer) that stores and manages information about the registered monitoring target(s), the registered remote monitor(s), and the group member(s). In addition, the service customers DB 111 stores information in which the registered monitoring target(s), the registered remote monitor(s), the group member(s), and the watcher(s) are associated with each other.

Next, the monitoring control apparatus 112 will be described in detail.

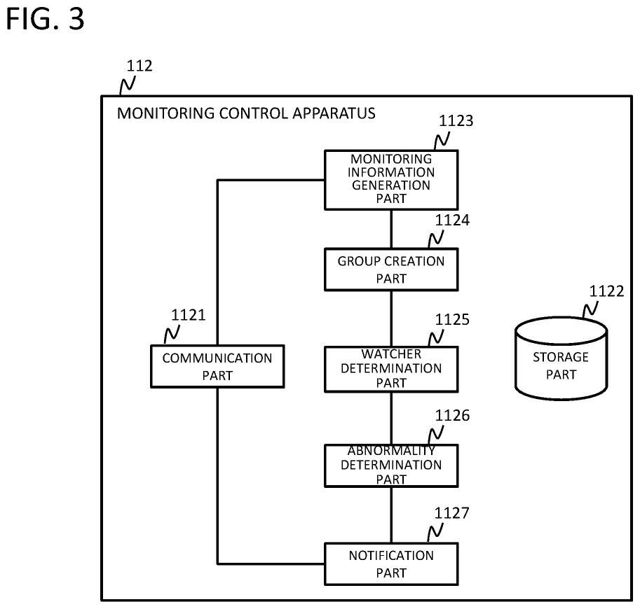

FIG. 3 is a block diagram illustrating an example of an internal configuration of the monitoring control apparatus 112. The monitoring control apparatus 112 includes a communication part 1121, a storage part 1122, a monitoring information generation part 1123, a group creation part 1124, a watcher determination part 1125, an abnormality determination part 1126, and a notification part 1127.

The communication part 1121 controls communication processing. For example, the communication part 1121 may be realized by using a NIC (Network Interface Card) or the like.

The storage part 1122 holds information necessary for operating the monitoring control apparatus 112. For example, the storage part 1122 may be realized by using a magnetic disk device, an optical disc device, a semiconductor memory, or the like. The storage part 1122 may hold a program for realizing the monitoring information generation part 1123, the group creation part 1124, the watcher determination part 1125, and the abnormality determination part 1126.

The monitoring information generation part 1123 generates monitoring information including the information about the communication statuses of the devices included in the premise networks of the plurality of customers. Specifically, the monitoring information generation part 1123 generates monitoring information corresponding to the premise device of the customers based on the connection session information managed by the NAT 180.

In the following description, the connection session information corresponding to the premise device(s) of the monitoring target(s) will be referred to as “first connection session information”. In addition, in the following description, the monitoring information corresponding to the premise device(s) of the monitoring target(s) will be referred to as “first monitoring information”.

In addition, in the following description, the connection session information corresponding to the premise device(s) of the group member(s) will be referred to as “second connection session information”. In addition, in the following description, the monitoring information corresponding to premise device(s) of the group member(s) will be referred to as “second monitoring information”.

More specifically, the monitoring information generation part 1123 requests the NAT 180 for the connection session information that is managed by the NAT 180 and that corresponds to a premise device of a customer. In response to the request from the monitoring information generation part 1123, the NAT 180 notifies the monitoring information generation part 1123 of the connection session information corresponding to the premise device of the customer. The monitoring information generation part 1123 generates the monitoring information about the device based on the connection session information given from the NAT 180.

In addition, the monitoring information generation part 1123 estimates a behavior pattern(s) of the monitoring target(s) based on the monitoring information (the first monitoring information) about the device(s) included in the premise network(s) of the monitoring target(s) and holds the estimated behavior pattern(s).

Specifically, the monitoring information generation part 1123 estimates, based on the monitoring information (the first monitoring information) about a device included in the premise network of a monitoring target, a time period in which the device is used and a time length in which the device is used. Next, the monitoring information generation part 1123 estimates a behavior pattern of the monitoring target, based on the time period in which the device is used and the time length in which the device is used. Next, the monitoring information generation part 1123 stores the behavior pattern of the monitoring target in the storage part 1122.

In addition, the monitoring information generation part 1123 generates presence information about the customers, based on the information about the kinds of the devices included in the premise networks of the customers and the monitoring information about the devices.

Specifically, the monitoring information generation part 1123 acquires information in which the information about the kinds of the devices and the private IP addresses allocated by the DHCP server 160 are associated with each other from the DHCP server 160. The monitoring information generation part 1123 determines whether an device is a monitoring device satisfying a predetermined condition(s) based on the acquired information about the kinds of the devices.

The monitoring control apparatus 112 may previously determine a device used by an individual as a monitoring device used. For example, the monitoring control apparatus 112 may previously determine a device used by an individual such as a smartphone, a wearable device, or the like as a monitoring device used. In this case, if the acquired information about the kind of an device indicates a monitoring device used, the monitoring information generation part 1123 determines a private IP address associated with the information about the kind of the monitoring device used. The private IP address associated with the information about the kind of the monitoring device used will hereinafter be referred to as “the IP address of the monitoring device used”.

The monitoring information generation part 1123 generates presence information about the customers, based on the monitoring information corresponding to the IP addresses of the determined monitoring devices used. Specifically, if the monitoring information corresponding to the IP address of a determined monitoring device used indicates “during communication”, the monitoring information generation part 1123 generates presence information indicating that the customer is home. In contrast, if the monitoring information corresponding to the IP address of a determined monitoring device used does not indicate “during communication”, the monitoring information generation part 1123 generates presence information indicating that the customer is not home.

The group creation part 1124 creates a group including two or more customers. Specifically, the group creation part 1124 creates a group including at least one customer different from the monitoring target(s) from the plurality of customers.

The group creation part 1124 may select at least one group member from the plurality of customers, based on the places of the residences of the plurality of customers.

For example, the group creation part 1124 may determine a customer who lives within a predetermined area from the address of a monitoring target, based on the address of the monitoring target and the addresses of the customers. The group creation part 1124 may create a group (hereinafter referred to as “a neighborhood group”) including a determined customer(s).

It is desirable that, to serve as a watcher, a customer satisfy a health status or condition. The present example assumes that the individual customer selects whether to agree to be a watcher candidate when participating in the monitoring service.

In addition, the group creation part 1124 creates a group including the at least one customer who has previously agreed to be a watcher candidate corresponding to the monitoring target(s) among the customers included in the group. The group creation part 1124 registers the created group in the service customer DB 111.

Alternatively, a customer(s) may determine his/her group member(s), depending on the monitoring target(s). For example, after agreement is made among customers, a customer(s) may input information identifying his/her group member(s) and information identifying the corresponding monitoring target(s) to his/her own terminal (for example, a smartphone or the like). The information identifying a group member may be an ID (Identifier), a contract number, or the like allocated to the group member. Likewise, the information identifying a monitoring target may be an ID allocated to the monitoring target, a contract number of the monitoring target, or the like.

For example, if a person(s) to be a watcher candidate(s) is previously determined in a community association or the like, the terminals used by the customers may be supplied with information identifying the determined person(s) as the information identifying the group member (for example, a neighborhood group).

The terminals used by the customers transmit the information identifying the group members and the information identifying the corresponding monitoring target(s) to the monitoring control apparatus 112. The monitoring control apparatus 112 determines the group members based on the received information identifying the group members. Next, the group creation part 1124 creates a group including the determined group members and registers the group in the service customer DB 111. In this case, if a group member is changed, the group creation part 1124 may request the customers for permission for change of the watcher group member.

The watcher determination part 1125 determines a watcher(s) corresponding to the monitoring target(s) from the plurality of customers by using the communication statuses of the devices included in the premise networks of the plurality of customers. The watcher determination part 1125 may determine two or more watchers for one monitoring target.

Specifically, the watcher determination part 1125 determines a customer satisfying a predetermined condition from the group as a watcher corresponding to a monitoring target, based on the monitoring information about the devices included in the premise networks of the customers included in the group.

The present example assumes that the watcher determination part 1125 selects, as watcher candidates, customers who can check the safety of the monitoring target from the previously registered customers. Specifically, the watcher determination part 1125 extracts the presence information about the watcher candidates corresponding to the monitoring target from the storage part 1122. Next, the watcher determination part 1125 selects watcher candidates from the customers included in the group based on the presence information. More specifically, the watcher determination part 1125 determines watcher candidates corresponding to the monitoring target and staying home, based on the presence information.

Next, the watcher determination part 1125 determines a customer(s) satisfying the predetermined conduction from the group as a watcher(s), based on the monitoring information about the devices included in the premise networks of the watcher candidates. Specifically, the watcher determination part 1125 determines a priority order of the determined watcher candidates based on a watcher history. The watcher history signifies information about the history of an individual customer as a watcher. The watcher history includes the year, month, and date when an individual customer has served as a watcher, for example.

For example, the watcher determination part 1125 may determine the priority order of the determined watcher candidates in such a manner that a customer who has served as a watcher a fewer number of times within a predetermined period has a higher priority.

The watcher determination part 1125 determines a predetermined number of watcher candidates (for example, the top two customers) as watchers based on the determined priority order.

The abnormality determination part 1126 determines whether an abnormal situation has happened to the monitoring target based on the monitoring information (the first monitoring information) of the devices included in the premise network of the monitoring target.

Specifically, when the difference between the behavior pattern of the monitoring target and the monitoring information (the first monitoring information) of the devices included in the premise network of the monitoring target exceeds a predetermined threshold, the abnormality determination part 1126 determines that an abnormal situation has happened to the monitoring target.

If an abnormal situation has happened to the monitoring target, the notification part 1127 notifies a watcher corresponding to this monitoring target of the occurrence of the abnormal situation.

By causing a CPU (Central Processing Unit) of the monitoring control apparatus 112 to read and execute a program stored in the storage part 1122, the monitoring information generation part 1123, the group creation part 1124, the watcher determination part 1125, and the abnormality determination part 1126 may be realized. Alternatively, for example, an individual one of the monitoring information generation part 1123, the group creation part 1124, the watcher determination part 1125, and the abnormality determination part 1126 may be realized by using different hardware.

Next, an operation of the monitoring system 1 according to the present exemplary embodiment will be described.

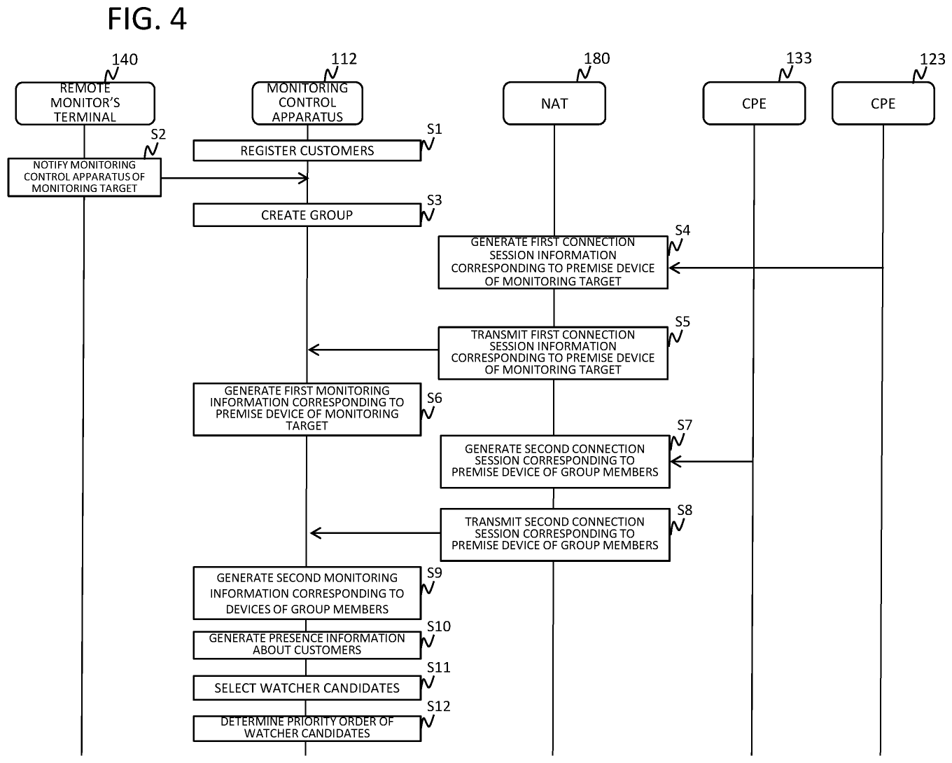

FIG. 4 is a sequence diagram illustrating an example of processing for selecting a watcher candidate.

In step S1, the monitoring control apparatus 112 registers customers.

Specifically, the monitoring control apparatus 112 receives requests for registration of customers and information about the customers from apparatuses different from the monitoring control apparatus 112. If the monitoring control apparatus 112 receives a request for registration of a new customer, the monitoring control apparatus 112 generates customer registration data in which information identifying the customer and information about the customer are associated with each other and registers the generated customer registration data in the customers DB 150.

The information about a customer includes the name and the address of the customer and information indicating whether the customer agrees to be a watcher candidate. The information about the customer may additionally include other information.

In addition, if the monitoring control apparatus 112 receives a registration request for a monitoring target, a remote monitor, or the like and information about the customers, the monitoring control apparatus 112 generates customer registration data in which the information identifying the customers and information about the customers are associated with each other. The information about a customer includes the name, the address, etc. of the customer. The monitoring control apparatus 112 registers the generated customer registration data in the customer DB 150. For example, an operator providing the monitoring system 1 according to the present exemplary embodiment may register the customer.

In the following description, the information identifying a remote monitor will be referred to as “remote monitor identification information”. In addition, in the following description, the information identifying a monitoring target will be referred to as “monitoring target identification information”. In addition, in the following description, the customer registration data corresponding to a remote monitor will be referred to as “remote monitor registration data”. In addition, in the following description, the customer registration data corresponding to a monitoring target will be referred to as “monitoring target registration data”.

In addition, a remote monitor installs an application program (which will hereinafter be referred to as “a client application”) for using the monitoring system 1 in the remote monitor's terminal 140.

In step S2, the remote monitor's terminal 140 notifies the monitoring control apparatus 112 of a monitoring target. The following description assumes that the monitoring target is a monitoring target reported by the remote monitor's terminal 140 in step S2.

Specifically, the remote monitor uses the remote monitor's terminal 140 to input the information identifying the monitoring target. The remote monitor's terminal 140 notifies the UI server 113 of the information identifying the monitoring target and the information identifying the remote monitor. The UI server 113 transmits the received information identifying the monitoring target and the received information identifying the remote monitor to the monitoring control apparatus 112.

The monitoring control apparatus 112 registers the customer registration data corresponding to the received information identifying the remote monitor in the service customers DB 111 as the remote monitor registration data. In addition, the monitoring control apparatus 112 registers the customer registration data corresponding to the received information identifying the monitoring target in the service customers DB 111 as the monitoring target registration data corresponding to the remote monitor.

For example, the group creation part 1124 refers to the customers DB 150 and the service customers DB 111. Next, the group creation part 1124 determines customers who live within a predetermined area from the address of the monitoring target and who have agreed to be watcher candidates. Next, the group creation part 1124 creates a group (a neighborhood group) including the determined customers.

In step S4, the NAT 180 generates the first connection session information corresponding to a premise device of the monitoring target. Specifically, if the NAT 180 receives a packet from the CPE 123 in the residence of the monitoring target, the NAT 180 generates the first connection session information corresponding to a premise device of the monitoring target. In step S5, the NAT 180 transmits the first connection session information corresponding to the premise device of the monitoring target to the monitoring control apparatus 112.

In step S6, the monitoring information generation part 1123 generates the first monitoring information corresponding to the premise device of the monitoring target.

In step S7, the NAT 180 generates the second connection session information corresponding to the premise devices of the group members. Specifically, if the NAT 180 receives a packet from the CPE 133 in the residence of a group member, the NAT 180 generates the second connection session information corresponding to a premise device of the watcher candidate. In step S8, the NAT 180 transmits the second connection session information corresponding to the premise devices of the group members to the monitoring control apparatus 112.

In step S9, the monitoring information generation part 1123 generates the second monitoring information corresponding to the devices of the group members.

In step S10, the monitoring information generation part 1123 generates presence information about the customers. Specifically, the monitoring information generation part 1123 generates presence information about the monitoring target, based on the monitoring information corresponding to the IP address of the monitoring device used in the residence of the monitoring target. In addition, the monitoring information generation part 1123 generates presence information about the group members. Specifically, the monitoring information generation part 1123 generates presence information about the group members, based on the monitoring information corresponding to the IP addresses of the monitoring devices used in the residences of the group members.

In step S11, the watcher determination part 1125 selects watcher candidates. Specifically, the watcher determination part 1125 determines group members who are home based on the presence information. The watcher determination part 1125 selects watcher candidates from the group members who are home.

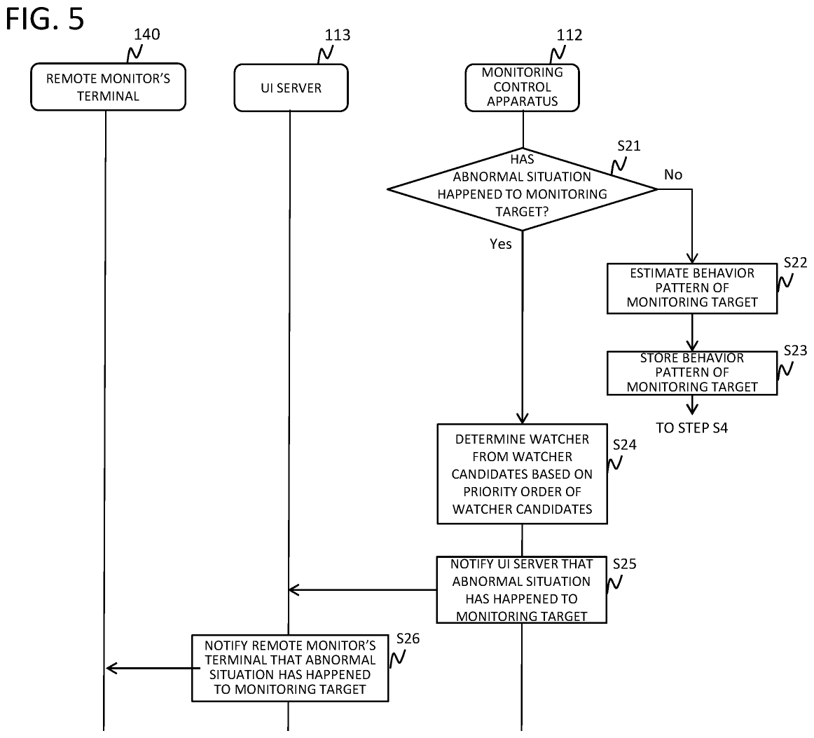

In step S12, the watcher determination part 1125 determines the priority order of watcher candidates based on the watcher history. Next, the processing proceeds to step S21 in FIG. 5.

FIG. 5 is a sequence diagram illustrating an example of processing for determining whether an abnormal situation has happened to the monitoring target.

In step S21, the abnormality determination part 1126 determines whether an abnormal situation has happened to the monitoring target. If the abnormality determination part 1126 does not determine that an abnormal situation has happened to the monitoring target (No in step S21), the monitoring information generation part 1123 estimates the behavior pattern of the monitoring target (step S22). Next, the monitoring information generation part 1123 stores the behavior pattern of the monitoring target in the storage part 1122 (step S23). Next, the processing returns to step S4.

In contrast, if the abnormality determination part 1126 determines that an abnormal situation has happened to the monitoring target (Yes in step S21), the watcher determination part 1125 determines a watcher from the watcher candidates based on the priority order of the watcher candidates (step S24). In this step, the watcher determination part 1125 may determine two or more watchers.

In step S25, the abnormality determination part 1126 notifies the UI server 113 that the abnormal situation has happened to the monitoring target.

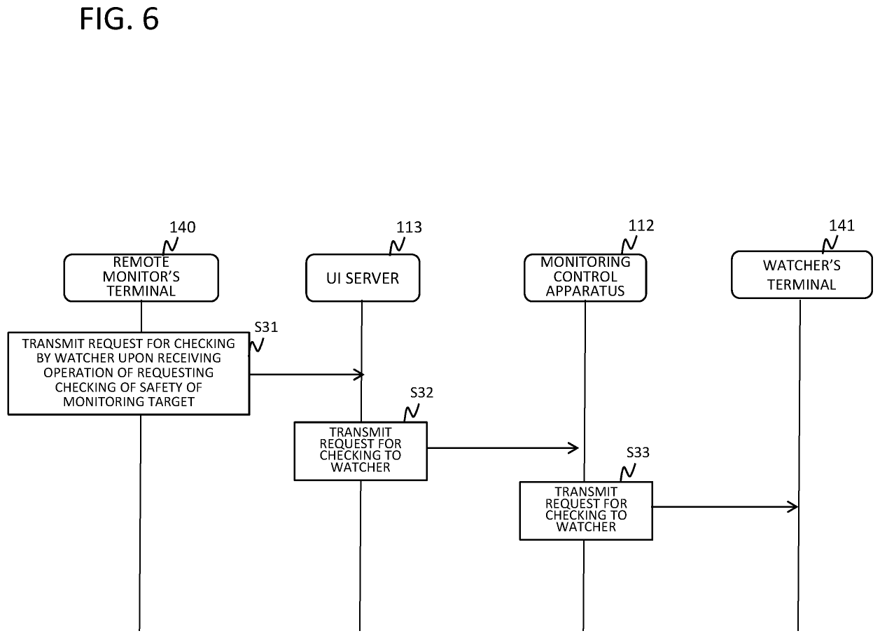

The UI server 113 is notified by the monitoring control apparatus 112 that the abnormal situation has happened to the monitoring target. In step S26, the UI server 113 notifies the remote monitor's terminal 140 that the abnormal situation has happened to the monitoring target. Next, the processing proceeds to step S31 in FIG. 6.

FIG. 6 is a sequence diagram illustrating an example of processing for notifying the watcher that the abnormal situation has happened to the monitoring target. In the following description, a terminal (a smartphone or the like) used by the watcher will be referred to as a “watcher's terminal” 141.

This example assumes that the remote monitor's terminal 140 has been notified that the abnormal situation has happened to the monitoring target. In this case, the remote monitor uses the remote monitor's terminal 140 to check that the abnormal situation has happened to the monitoring target. If the remote monitor's terminal 140 checks that the abnormal situation has happened to the monitoring target, the remote monitor may call, for example, the terminal 121 of the monitoring target to check the safety of the monitoring target.

If the remote monitor requests the watcher to check the safety of the monitoring target, the remote monitor uses the remote monitor's terminal 140 to request the watcher to check the safety of the monitoring target.

For example, the client application installed in the remote monitor's terminal 140 may display a menu “Request the watcher to check the safety of the monitoring target” on its display screen. In this case, the remote monitor may select the menu “Request the watcher to check the safety of the monitoring target” displayed on the remote monitor's terminal 140 and execute an operation of requesting the watcher to check the safety of the monitoring target.

If the remote monitor's terminal 140 receives the operation of requesting the watcher to check the safety of the monitoring target, the remote monitor's terminal 140 transmits the request for checking by the watcher to the UI server 113 (step S31).

The UI server 113 receives the request for checking by the watcher from the remote monitor's terminal 140. In step S32, the UI server 113 transmits the request for checking by the watcher to the monitoring control apparatus 112.

The monitoring control apparatus 112 receives the request for checking by the watcher from the UI server 113. In step S33, the monitoring control apparatus 112 transmits the request for checking by the watcher to the watcher's terminal 141. Specifically, if the monitoring control apparatus 112 receives the request for checking by the watcher from the UI server 113, the abnormality determination part 1126 determines the terminal (the watcher's terminal 141) used by the watcher, based on the information identifying the watcher (an ID, a contract number, or the like allocated to the watcher). Next, the notification part 1127 transmits a notification requesting checking of the safety of the monitoring target to the determined watcher's terminal 141.

### [Variation 1]

As variation 1 of the monitoring system 1 according to the present exemplary embodiment, a single information processing apparatus (a computer) may be configured to include the functions of the service customers DB 111, the monitoring control apparatus 112, and the UI server 113.

As described above, the monitoring system 1 according to the present exemplary embodiment uses the NAT 180 based on vCPE and collectively monitors the communication statuses of the premise devices of the respective customers of the monitoring system 1. Next, the monitoring control apparatus 112 according to the present exemplary embodiment determines whether the customers are home based on the communication statuses of their premise devices. In addition, the monitoring control apparatus 112 according to the present exemplary embodiment estimates the behavior pattern of the monitoring target based on the communication status of the corresponding premise devices of the monitoring target.

Thus, the monitoring control apparatus 112 according to the present exemplary embodiment can monitor the monitoring target without making the monitoring target aware of being monitored.

In addition, the monitoring control apparatus 112 according to the present exemplary embodiment determines whether an abnormal situation has happened to the monitoring target based on the communication status of the premise devices of the monitoring target and the behavior pattern of the monitoring target.

Thus, even if the monitoring target cannot report his/her own abnormal situation, the monitoring control apparatus 112 according to the present exemplary embodiment can detect the abnormal situation that has happened to the monitoring target.

In addition, the monitoring control apparatus 112 according to the present exemplary embodiment selects customers who have agreed to check the safety of the monitoring target as group members. In addition, the monitoring control apparatus 112 according to the present exemplary embodiment determines a group member who is home among the selected group members as a watcher of the monitoring target. In addition, if an abnormal situation has happened to the monitoring target, the monitoring control apparatus 112 according to the present exemplary embodiment notifies the watcher that the abnormal situation has happened to the monitoring target.

Thus, the monitoring system 1 according to the present exemplary embodiment contributes to requesting a watcher selected from customers of the monitoring service to check the safety of the monitoring target.

For example, in the monitoring system 1 according to the present exemplary embodiment, if an abnormal situation has happened to an elderly person living alone (the monitoring target), a person (a watcher) who lives near the elderly person living alone and who has been selected from the customers in the monitoring system 1 checks the safety of the elderly person living alone.

In addition, in the monitoring system 1 according to the present exemplary embodiment, since a watcher selected from the customers of the monitoring system 1 checks the safety of the monitoring target, burden on caregivers, etc. is reduced.

Thus, the monitoring system 1 according to the present exemplary embodiment contributes to checking the safety of the monitoring target through mutual cooperation of customers of the monitoring service.

### Second Exemplary Embodiment

Next, a second exemplary embodiment will be described in detail with reference to drawings.

The present exemplary embodiment is a mode in which an alarm control apparatus monitors an alarm apparatus installed in the residence of a monitoring target and notifies, if the alarm apparatus outputs an alarm, a watcher that the alarm apparatus has outputted an alarm. In the description of the present exemplary embodiment, description of the part that overlaps with the above exemplary embodiment will be omitted. In addition, in the description of the present exemplary embodiment, the same constituent elements as those according to the above exemplary embodiment will be denoted by the same reference characters, and the description thereof will be omitted. In addition, in the description of the present exemplary embodiment, the description of the same operations and effects as those according to the above exemplary embodiment will be omitted.

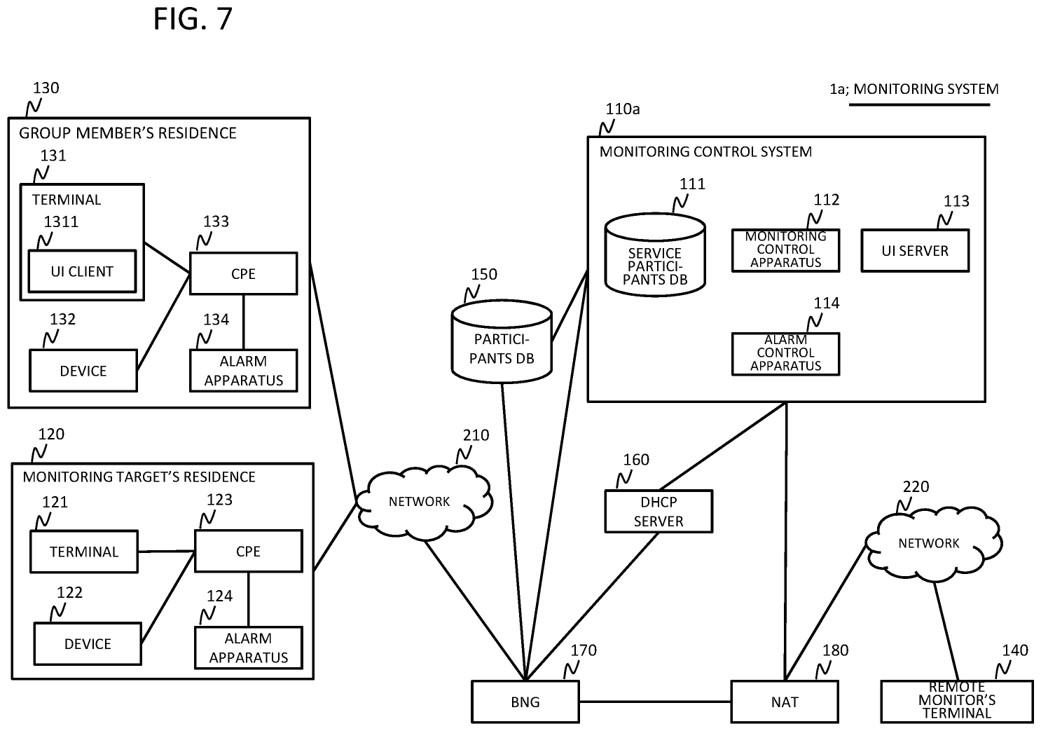

FIG. 7 is a block diagram illustrating an example of an overall configuration of a monitoring system 1a according to the present exemplary embodiment. The monitoring system 1a illustrated in FIG. 7 differs from the monitoring system 1 illustrated in FIG. 2 in that the monitoring system 1a illustrated in FIG. 7 includes an alarm apparatus 124 and an alarm apparatus 134. In addition, the monitoring control system 110a illustrated in FIG. 7 differs from the monitoring control system 110 illustrated in FIG. 2 in that the monitoring control system 110a illustrated in FIG. 7 includes an alarm control apparatus 114.

The alarm apparatus 124 (a first alarm apparatus) is an apparatus that is installed in the residence of the monitoring target and that outputs an alarm. In addition, the alarm apparatus 134 (a second alarm apparatus) is installed in the residence of the group member and outputs an alarm. The alarm apparatus 124 and the alarm apparatus 134 are connected to the alarm control apparatus 114 via the network 210.

The alarm apparatus 124 includes a sensor that measures a predetermined physical amount, an output part that outputs an alarm, and a control part that controls the output of the alarm.

For example, the alarm apparatus 124 may include a sensor that detects carbon monoxide. The alarm apparatus 124 may be an apparatus that outputs an alarm when detecting carbon monoxide.

For example, the alarm apparatus 124 may include a sensor that detects smoke. The alarm apparatus 124 may be an apparatus that outputs an alarm when detecting smoke whose density is over a predetermined density.

For example, the alarm apparatus 124 may include a sensor that measures the temperature. The alarm apparatus 124 may be an apparatus that outputs an alarm when detecting the temperature exceeding a predetermined threshold. The alarm apparatus 124 may measure any one of various kinds of physical amounts, and the physical amount measured by the alarm apparatus 124 is not particularly limited to any specific physical amount.

The alarm control apparatus 114 monitors the alarm apparatus 124 (the first alarm apparatus) installed in the residence of the monitoring target. The alarm control apparatus 114 causes the alarm apparatus 134 (the second alarm apparatus) installed in the residence of the watcher to output an alarm when the alarm apparatus 124 outputs an alarm.

Next, an operation of the monitoring system 1a according to the present exemplary embodiment will be described in detail.

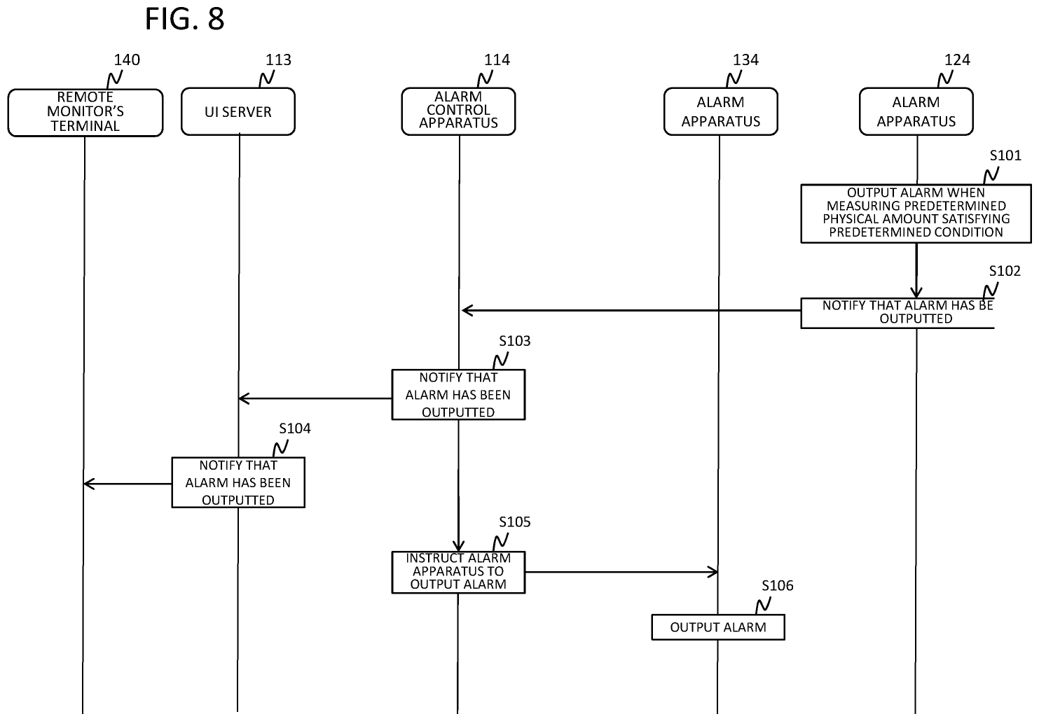

FIG. 8 is a sequence diagram illustrating an example of an operation of the monitoring system 1a according to the present exemplary embodiment.

When the alarm apparatus 124 detects a predetermined physical amount (smoke, the temperature, or the like) satisfying a predetermined condition, the alarm apparatus 124 outputs an alarm (step S101).

In step S102, the alarm apparatus 124 notifies the alarm control apparatus 114 that the alarm apparatus 124 has outputted an alarm.

In step S103, the alarm control apparatus 114 notifies the UI server 113 that the alarm apparatus 124 has outputted an alarm.

The UI server 113 is notified by the monitoring control apparatus 112 that the alarm apparatus 124 has outputted an alarm. In step S104, the UI server 113 notifies the remote monitor's terminal 140 that the alarm apparatus 124 has outputted an alarm.

In step S105, the alarm control apparatus 114 instructs the alarm apparatus 134 to output an alarm.

In step S106, the alarm apparatus 134 outputs an alarm.

### [Variation 1]

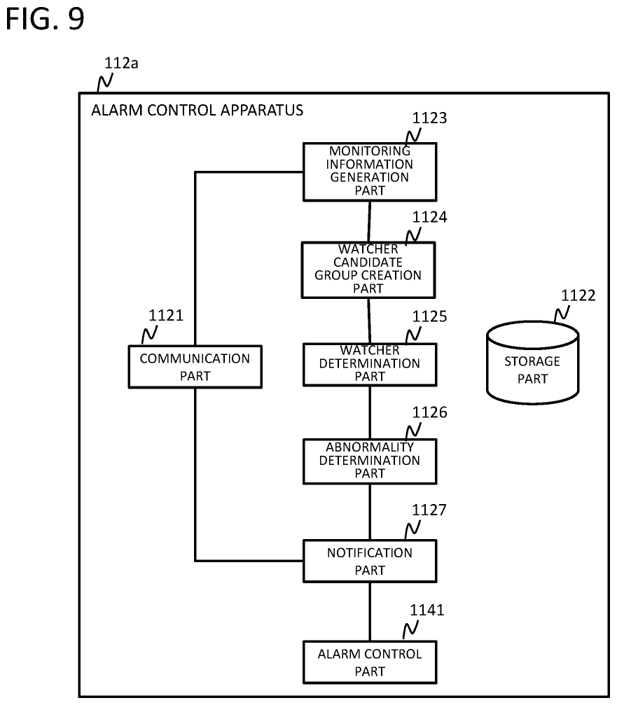

As variation 1 of the monitoring system 1a according to the present exemplary embodiment, a monitoring control apparatus 112a may realize the function of the alarm control apparatus 114. FIG. 9 is a block diagram illustrating an example of an internal configuration of the monitoring control apparatus 112a. The monitoring control apparatus 112a illustrated in FIG. 9 differs from the monitoring control apparatus 112 illustrated in FIG. 3 in that the monitoring control apparatus 112a includes an alarm control part 1141 that realizes the function of the alarm control apparatus 114. The alarm control part 1141 performs the same processing as that of the alarm control apparatus 114. Namely, the alarm control part 1141 monitors the alarm apparatus 124 (the first alarm apparatus) installed in the residence of the monitoring target. When the alarm apparatus 124 outputs an alarm, the alarm control part 1141 causes the alarm apparatus 134 (the second alarm apparatus) installed in the residence of a corresponding watcher to output an alarm.

### [Variation 2]

As variation 2 of the monitoring system 1a according to the present exemplary embodiment, a single information processing apparatus (a computer) may include the functions of the service customers DB 111, the monitoring control apparatus 112, the UI server 113, and the alarm control apparatus 114.

As described above, in the monitoring system 1a according to the present exemplary embodiment, when the alarm apparatus 124 installed in the residence of the monitoring target outputs an alarm, the alarm control apparatus 114 causes the alarm apparatus 134 installed in the residence of a corresponding watcher to output an alarm. As a result, in the monitoring system 1a according to the present exemplary embodiment, the watcher can be notified that an abnormal situation has happened to the monitoring target before requested by a corresponding remote monitor to check the safety of the monitoring target.

For example, in the monitoring system 1a according to the present exemplary embodiment, a person (a watcher) living near an elderly person living alone (the monitoring target) is able to know that an abnormal situation has happened to the elderly person living alone before requested by a family member (remote monitor) of the elderly person living alone to check the safety of the elderly person.

Thus, in the monitoring system 1a according to the present exemplary embodiment, the monitoring control apparatus 112 can allow the watcher to check the safety of the monitoring target more quickly. Thus, the monitoring system 1a according to the present exemplary embodiment contributes to checking the safety of the monitoring target more quickly through mutual cooperation of customers of the monitoring service.

### Third Exemplary Embodiment

Next, a third exemplary embodiment will be described in detail with reference to drawings.

The present exemplary embodiment is a mode in which a locking control apparatus controls authority to unlock an entrance door of a monitoring target and gives this authority to unlock the entrance door of the monitoring target to a watcher. In the description of the present exemplary embodiment, the part that overlaps with the above exemplary embodiments will be omitted. In addition, in the description of the present exemplary embodiment, the same constituent elements as those according to the above exemplary embodiment(s) will be denoted by the same reference characters, and the description thereof will be omitted. In addition, in the description of the present exemplary embodiment, the description of the same operations and effects as those according to the above exemplary embodiment(s) will be omitted.

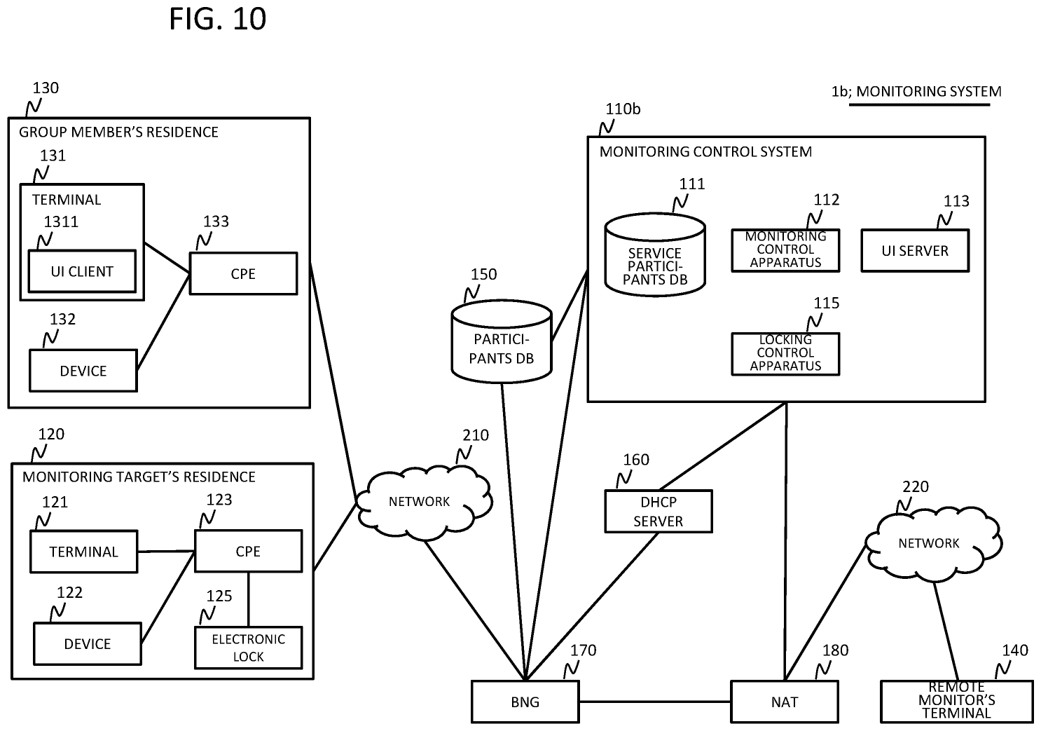

FIG. 10 is a block diagram illustrating an example of an overall configuration of a monitoring system 1b according to the present exemplary embodiment. The monitoring system 1b illustrated in FIG. 10 differs from the monitoring system 1 illustrated in FIG. 2 in that the monitoring system 1b illustrated in FIG. 10 includes an electronic lock 125. The monitoring control system 110b illustrated in FIG. 10 differs from the monitoring control system 110 illustrated in FIG. 2 in that the monitoring control system 110b illustrated in FIG. 10 includes a locking control apparatus 115.

The electronic lock 125 is a locking device that is installed at an entrance door of a monitoring target and that unlocks the entrance door when receiving a predetermined electric signal. The following description assumes that a mobile terminal (for example, the terminal 121, the terminal 131) has a function of outputting an electric signal for unlocking the electronic lock 125. Specifically, when the user of a mobile terminal (for example, the terminal 121, the terminal 131) has the authority to unlock the electronic lock 125, the mobile terminal (for example, the terminal 121, the terminal 131) outputs electric signals for locking and unlocking the electronic lock 125.

The locking control apparatus 115 controls the authority to unlock the entrance door of the monitoring target.

In addition, if an abnormal situation has happened to the monitoring target, the locking control apparatus 115 gives the authority to unlock the entrance door of the monitoring target to a watcher.

The present example assumes that the locking control apparatus 115 temporarily gives the authority to unlock the entrance door of the monitoring target to the watcher. For example, the locking control apparatus 115 may allow the watcher to have the authority to unlock the entrance door of the monitoring target for only a predetermined time (for example, one hour).

Alternatively, the locking control apparatus 115 may allow the watcher to unlock the entrance door of the monitoring target only a predetermined number of times (for example, once).

If the watcher does not unlock the entrance door of the monitoring target within a redetermined time (for example, within one hour), the locking control apparatus 115 may deprive the watcher of the authority to unlock the entrance door of the monitoring target.

Next, an operation of the monitoring system 1b according to the present exemplary embodiment will be described in detail.

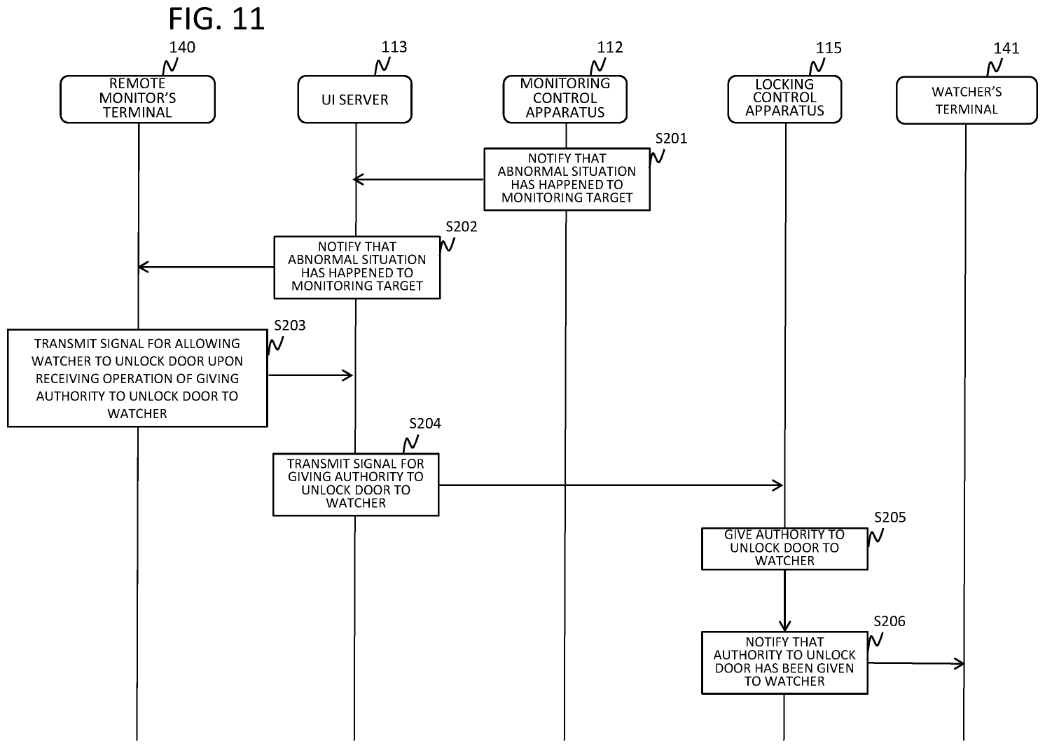

FIG. 11 is a sequence diagram illustrating an example of an operation of the monitoring system 1b according to the present exemplary embodiment.

If the abnormality determination part 1126 determines that an abnormal situation has happened to the monitoring target, the monitoring control apparatus 112 notifies the UI server 113 that the abnormal situation has happened to the monitoring target (step S201).

The UI server 113 is notified by the monitoring control apparatus 112 that the abnormal situation has happened to the monitoring target. In step S202, the UI server 113 notifies the remote monitor's terminal 140 that the abnormal situation has happened to the monitoring target.

The remote monitor uses the remote monitor's terminal 140 to check that the abnormal situation has happened to the monitoring target. If the remote monitor comes to know that the abnormal situation has happened to the monitoring target, the remote monitor may check the safety of the monitoring target by, for example, calling the terminal 121 of the monitoring target.

When the remote monitor requests a corresponding watcher to enter the residence of the monitoring target and check the safety of the monitoring target, the remote monitor uses the remote monitor's terminal 140 to allow the watcher to unlock the electronic lock 125 of the monitoring target's residence 120.

For example, a client application installed in the remote monitor's terminal 140 may display a menu “Give the authority to unlock the door to the watcher” on a display screen. Next, the remote monitor may select the menu “Give the authority to unlock the door to the watcher” displayed on the remote monitor's terminal 140 and perform an operation of giving the authority to unlock the door to the watcher.

If the remote monitor's terminal 140 receives the operation of giving the authority to unlock the door to the watcher, the remote monitor's terminal 140 transmits a signal for giving the authority to unlock the door to the watcher to the UI server 113 (step S203).

In step S204, the UI server 113 transmits the signal for giving the authority to unlock the door to the watcher to the locking control apparatus 115.

In step S205, the locking control apparatus 115 gives the authority to unlock the door to the watcher.

In step S206, the locking control apparatus 115 notifies the watcher's terminal 141 used by the watcher that the authority to unlock the door has been given to the watcher.

The watcher uses the watcher's terminal 141 to unlock the electronic lock 125 installed at the monitoring target's residence 120 and checks the safety of the monitoring target.

### [Variation 1]

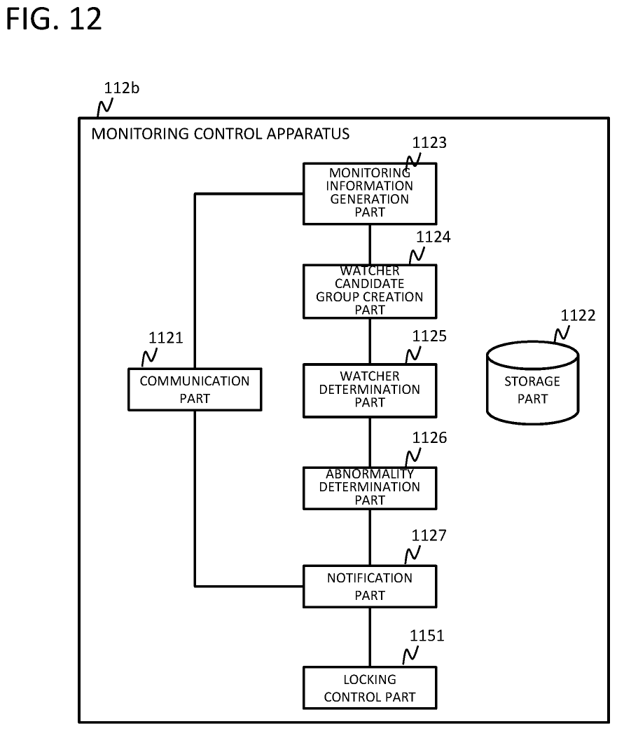

As variation 1 of the monitoring system 1b according to the present exemplary embodiment, a monitoring control apparatus 112b may realize the function of the locking control apparatus 115. FIG. 12 is a block diagram illustrating an example of an internal configuration of the monitoring control apparatus 112b. The monitoring control apparatus 112b illustrated in FIG. 12 differs from the monitoring control apparatus 112 illustrated in FIG. 3 in that the monitoring control apparatus 112b includes a locking control part 1151 that realizes the function of the locking control apparatus 115. The locking control part 1151 performs the same processing as that of the locking control apparatus 115. Namely, the locking control part 1151 controls the authority to unlock an entrance door of a monitoring target. In addition, when an abnormal situation has happened to the monitoring target, the locking control part 1151 gives the authority to unlock the entrance door of the monitoring target to a corresponding watcher.

### [Variation 2]

As variation 2 of the monitoring system 1b according to the present exemplary embodiment, a single information processing apparatus (a computer) may include the functions of the service customers DB 111, the monitoring control apparatus 112, the UI server 113, and the locking control apparatus 115.

As described above, in the monitoring system 1b according to the present exemplary embodiment, when an abnormal situation has happened to the monitoring target, the monitoring control apparatus 112 gives the authority to unlock an entrance door of the monitoring target's residence 120 to a corresponding watcher. As a result, in the monitoring system 1b according to the present exemplary embodiment, even if the entrance door of the monitoring target's residence 120 is locked, the watcher can check the safety of the monitoring target.

For example, in the monitoring system 1b according to the present exemplary embodiment, even if an entrance door of an elderly person living alone (the monitoring target) is locked, a person (a watcher) living near the elderly person living alone can check the safety of the monitoring target.

Thus, in the monitoring system 1b according to the present exemplary embodiment, the monitoring control apparatus 112 can allow the watcher to check the safety of the monitoring target more quickly. Thus, the monitoring system 1b according to the present exemplary embodiment contributes to checking the safety of the monitoring target more quickly through mutual cooperation of customers in the monitoring service.

The above exemplary embodiments can partially or entirely be described but not limited to as the following modes.

### (Mode 1)

See the monitoring control apparatus according to the above first aspect.

### (Mode 2)

The monitoring control apparatus preferably according to mode 1, further including: a monitoring information generation part that generates monitoring information including information about the communication statuses of the devices; and a group creation part that creates a group(s) including two or more customers; wherein the watcher determination part determines, based on the monitoring information of the devices included in the premise networks of customers included in the group(s), the customers satisfying a predetermined condition(s) from the group(s) as the watcher(s) corresponding to the monitoring target(s).

### (Mode 3)

The monitoring control apparatus preferably according to mode 2; wherein the monitoring information generation part generates presence information about the customers based on information about kinds of the devices and the monitoring information about the devices included in the premise networks of the customers; and wherein the watcher determination part selects a watcher candidate(s) from the customers included in the group(s) based on the presence information.

### (Mode 4)

The monitoring control apparatus preferably according to mode 3; wherein the watcher determination part determines a priority order of the watcher candidate(s) based on a watcher history and determines the watcher(s) from the watcher candidate(s) based on the priority order.

### (Mode 5)

The monitoring control apparatus preferably according to any one of modes 2 to 4, further including: an abnormality determination part that determines whether an abnormal situation(s) has happened to the monitoring target(s) based on the monitoring information of the device(s) included in the premise network(s) of the monitoring target(s); wherein, when the abnormality determination part determines that the abnormal situation(s) has happened to the monitoring target(s), the notification part notifies the watcher(s) corresponding to the monitoring target(s) of the occurrence of the abnormal situation(s).

### (Mode 6)

The monitoring control apparatus preferably according to mode 5; wherein the monitoring information generation part estimates a behavior pattern(s) of the monitoring target(s) based on the monitoring information about the device(s) included in the premise network(s) of the monitoring target(s); and wherein, when the difference between the behavior pattern(s) and the monitoring information about the device(s) included in the premise network(s) of the monitoring target(s) exceeds a predetermined threshold, the abnormality determination part determines that the abnormal situation(s) has happened to the monitoring target(s).

### (Mode 7)

The monitoring control apparatus preferably according to any one of modes 2 to 6; wherein the group creation part creates the group(s) including at least one of the customers from the plurality of customers based on places of residences of the plurality of customers.

### (Mode 8)

The monitoring control apparatus preferably according to any one of modes 1 to 7, further including an alarm control part that monitors a first alarm apparatus(es) installed in a residence(s) of the monitoring target(s) and causes a second alarm apparatus(es) installed in a residence(s) of the watcher(s) to output an alarm when the first alarm apparatus(es) outputs an alarm.

### (Mode 9)

The monitoring control apparatus preferably according to any one of modes 1 to 8, further including a locking control part that controls authority to unlock an entrance door(s) of the residence(s) of the monitoring target(s); wherein the locking control part gives the authority to unlock the entrance door(s) to the watcher(s) when the abnormal situation(s) has happened to the monitoring target(s).

### (Mode 10)

See the monitoring system according to the above second aspect.

### (Mode 11)

The monitoring system preferably according to mode 10, further including an alarm control apparatus that monitors a first alarm apparatus(es) installed in a residence(s) of the monitoring target(s) and causes a second alarm apparatus(es) installed in a residence(s) of the watcher(s) to output an alarm when the first alarm apparatus(es) outputs an alarm.

### (Mode 12)

The monitoring system preferably according to mode 10 or 11, further including a locking control part that controls authority to unlock an entrance door(s) of the residence(s) of the monitoring target(s); wherein the locking control part gives the authority to unlock the entrance door(s) to the watcher(s) when the abnormal situation(s) has happened to the monitoring target(s).

### (Mode 13)

See the monitoring control method according to the above third aspect.

### (Mode 14)

See the program according to the above fourth aspect.

The disclosure of the above PTLs is incorporated herein by reference thereto. Variations and adjustments of the exemplary embodiments are possible within the scope of the overall disclosure (including the claims) of the present invention and based on the basic technical concept of the present invention. Various combinations and selections of various disclosed elements (including the elements in each of the claims, exemplary embodiments, drawings, etc.) are possible within the scope of the overall disclosure of the present invention. Namely, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed. It is obvious that a computer is used when an algorithm, software, a flowchart, or an automated process step is indicated in the present invention, and it is also obvious that a processor and a memory or a storage apparatus are attached to the computer. Thus, even when these facts are not clearly specified, it should be understood that the present application of course includes these elements.

### REFERENCE SIGNS LIST

1, 1a, 1b monitoring system
10, 112, 112a, 112b monitoring control apparatus
11, 1125 watcher determination part
12, 1127 notification part
110, 110a, 110b monitoring control system
111 service customers DB
113 UI server
114 alarm control apparatus
115 locking control apparatus
120 monitoring target's residence
121, 131 terminal
122, 132 device
123, 133 CPE
124, 134 alarm apparatus
125 electronic lock
130 group member's residence
140 remote monitor's terminal
141 watcher's terminal
150 customers DB
160 DHCP server
170 BNG
180 NAT
210, 220 network
1121 communication part
1122 storage part
1123 monitoring information generation part
1124 group creation part
1126 abnormality determination part
1141 alarm control part
1151 locking control part
1311 UI client

1. A monitoring control apparatus, comprising:
at least one memory configured to store instructions; and
at least one processor configured to execute the instructions, to perform:
determining, by using communication statuses of devices included in premise networks of a plurality of customers, a watcher(s) corresponding to a monitoring target(s) from the plurality of customers; and
notifying, when an abnormal situation(s) has happened to the monitoring target(s), the watcher(s) of the occurrence of the abnormal situation(s).

2. The monitoring control apparatus according to claim 1, the instructions comprising:
generating monitoring information including information about the communication statuses of the devices;
creating a group(s) including two or more customers; and
determining, based on the monitoring information, a customer(s) satisfying a predetermined condition(s) from the group(s) as the watcher(s) corresponding to the monitoring target(s).

3. The monitoring control apparatus according to claim 2; the instructions comprising:
generating presence information about the customers based on information about kinds of the devices and the monitoring information about the devices included in the premise networks of the customers; and
selecting a watcher candidate(s) from the customers included in the group(s) based on the presence information.

4. The monitoring control apparatus according to claim 3; the instructions comprising:
determining a priority order of the watcher candidate(s) based on a watcher history and determines the watcher(s) from the watcher candidate(s) based on the priority order.

5. The monitoring control apparatus according to claim 2, the instructions comprising:
determining whether an abnormal situation(s) has happened to the monitoring target(s) based on the monitoring information of the device(s) included in the premise network(s) of the monitoring target(s); and
notifying, when the abnormal situation(s) has happened to the monitoring target(s), the watcher(s) corresponding to the monitoring target(s) of the occurrence of the abnormal situation(s).

6. The monitoring control apparatus according to claim 5; the instructions comprising:
estimating a behavior pattern(s) of the monitoring target(s) based on the monitoring information about the device(s) included in the premise network(s) of the monitoring target(s); and
determining, when the difference between the behavior pattern(s) and the monitoring information about the device(s) included in the premise network(s) of the monitoring target(s) exceeds a predetermined threshold, that the abnormal situation(s) has happened to the monitoring target(s).

7. The monitoring control apparatus according to claim 2; the instructions comprising:
creating the group(s) including at least one of the customers from the plurality of customers based on places of residences of the plurality of customers.

8. The monitoring control apparatus according to claim 1, the instructions comprising:
monitoring a first alarm apparatus(es) installed in a residence(s) of the monitoring target(s) and causes a second alarm apparatus(es) installed in a residence(s) of the watcher(s) to output an alarm when the first alarm apparatus(es) outputs an alarm.

9. The monitoring control apparatus according to claim 1, the instructions comprising:
controlling authority to unlock an entrance door(s) of the residence(s) of the monitoring target(s);
giving the authority to unlock the entrance door(s) to the watcher(s) when the abnormal situation(s) has happened to the monitoring target(s).

10. A monitoring system, comprising:
a communication control apparatus that acquires communication statuses of devices included in a premise network(s) of a plurality of customers; and
a monitoring control apparatus that acquires the communication statuses from the communication control apparatus;
wherein the monitoring control apparatus includes:
a watcher determination part that determines, by using the communication statuses of the devices included in the premise network(s) of the plurality of customers, a watcher(s) corresponding to a monitoring target(s) from the plurality of customers; and
a notification part that notifies, when an abnormal situation(s) has happened to the monitoring target(s), the watcher(s) of the occurrence of the abnormal situation(s).

11. The monitoring system according to claim 10, further comprising an alarm control apparatus that monitors a first alarm apparatus(es) installed in a residence(s) of the monitoring target(s) and causes a second alarm apparatus(es) installed in a residence(s) of the watcher(s) to output an alarm when the first alarm apparatus(es) outputs an alarm.

12. The monitoring system according to claim 10, further comprising:
a locking control part that controls authority to unlock an entrance door(s) of the residence(s) of the monitoring target(s);
wherein the locking control part gives the authority to unlock the entrance door(s) to the watcher(s) when the abnormal situation(s) has happened to the monitoring target(s).

13. A monitoring control method, comprising:
determining, by using communication information about devices included in premise networks of a plurality of customers, a watcher(s) corresponding to a monitoring target(s) from the plurality of customers; and
notifying, when an abnormal situation(s) has happened to the monitoring target(s), the watcher(s) of the occurrence of the abnormal situation(s).

14. (canceled)

15. The monitoring control method according to claim 13, comprising:
generating monitoring information including information about the communication statuses of the devices;
creating a group(s) including two or more customers; and
determining, based on the monitoring information, a customer(s) satisfying a predetermined condition(s) from the group(s) as the watcher(s) corresponding to the monitoring target(s).

16. The monitoring control method according to claim 15; comprising:
generating presence information about the customers based on information about kinds of the devices and the monitoring information about the devices included in the premise networks of the customers; and
selecting a watcher candidate(s) from the customers included in the group(s) based on the presence information.

17. The monitoring control method according to claim 16; comprising:
determining a priority order of the watcher candidate(s) based on a watcher history and determines the watcher(s) from the watcher candidate(s) based on the priority order.

18. The monitoring control method according to claim 15, comprising:
determining whether an abnormal situation(s) has happened to the monitoring target(s) based on the monitoring information of the device(s) included in the premise network(s) of the monitoring target(s); and
notifying, when the abnormal situation(s) has happened to the monitoring target(s), the watcher(s) corresponding to the monitoring target(s) of the occurrence of the abnormal situation(s).

19. The monitoring control method according to claim 18; comprising:
estimating a behavior pattern(s) of the monitoring target(s) based on the monitoring information about the device(s) included in the premise network(s) of the monitoring target(s); and
determining, when the difference between the behavior pattern(s) and the monitoring information about the device(s) included in the premise network(s) of the monitoring target(s) exceeds a predetermined threshold, that the abnormal situation(s) has happened to the monitoring target(s).

20. The monitoring control method according to claim 15; comprising:
creating the group(s) including at least one of the customers from the plurality of customers based on places of residences of the plurality of customers.

21. The monitoring control method according to claim 13, comprising:
monitoring a first alarm apparatus(es) installed in a residence(s) of the monitoring target(s) and causes a second alarm apparatus(es) installed in a residence(s) of the watcher(s) to output an alarm when the first alarm apparatus(es) outputs an alarm.
